(19) United States
(12) Patent Application Publication
(10) Pub. No.: US 2016/0016836 A1
(43) Pub. Date: Jan. 21, 2016

(54) Greywater Recycling System

(71) Applicant: Green Water Innovations, LLC, Tucson, AZ (US)

(72) Inventors: John J. Sudnick, Greer, SC (US); Robert P. Stevens, Greer, SC (US)

(73) Assignee: GREEN WATER INNOVATIONS, L.L.C., Tucson, AZ (US)

(21) Appl. No.: 14/591,888

(22) Filed: Jan. 7, 2015

Related U.S. Application Data
(60) Provisional application No. 61/924,602, filed on Jan. 7, 2014.

(51) Int. Cl. C02F 9/00; C02F 1/00

(52) U.S. Cl. CPC C02F 9/00; C02F 1/008; C02F 1/441

(57) ABSTRACT

A greywater recycling system. The system is designed using flow control management and minimally-sized holding tanks allowing use of on-site greywater recycling in locations where conventional greywater recycling systems are unsuitable. Where conventional greywater recycling systems produce low-value recycled water suitable for use in irrigation, the system produces high-value recycled water suitable for use in other systems, such as cooling towers with minimal impact on the facility and changes to existing processes. By using higher capacity extraction, reducing the size of storage tanks, and returning permeate to supply the extractor, as needed, the system operates efficiently while with a greywater source producing a non-continuous flow of greywater being modular and compact.

### BACKGROUND

Greywater encompasses non-industrial wastewater other than toilet wastewater (i.e., blackwater) and accounts for the majority of wastewater returned to the public sewer system and processed by publicly owned treatment works (POTW). Recovery and recycling of greywater offers valuable social and economic benefits by reducing the demand for fresh water.

Various businesses, such as hotels and hospitals, operate on-site commercial laundry facilities that generate significant amounts of greywater. In addition to paying for the clean water used in the laundry process, there is typically an additional wastewater treatment charge for the greywater returned to public utilities. Conventional greywater recycling systems produce treated greywater suitable for reuse in an irrigation system, which reduces wastewater treatment charges and the costs of obtaining clean water for irrigation for the business.

However, not all producers of greywater have a need for irrigation water and a private infrastructure for distributing reusable greywater where it is needed is rarely a practicable option. Laundry and similar operations do not produce a continuous flow of greywater. Instead, greywater is discharged in batches and collected in storage tanks for recycling once enough greywater has been collected. The large storage tanks used in conventional commercial scale greywater recycling systems occupy a considerable amount of space, which businesses may not have available. It is with respect to these and other considerations that the present invention has been made.

### BRIEF SUMMARY

Aspects found in various implementations of the present invention provide for greywater recycling in a compact, modular, and efficient system. The greywater recycling system removes gross solids via a gross solid screen component. Screened greywater is then passed through one or more physical filter stages to remove solid particles. Filtered greywater is stored, cooled, and concentrated in a small volume concentrator tank. The concentrator tank optionally includes energy recovery components. Chemical filters are used to remove undesirable chemicals and adjust the pH or other chemical parameters of the concentrated greywater. Once chemical processing is completed, an extractor employs a reverse osmosis unit with a capacity sized based on the greywater input rate to separate the greywater into permeate and reject/concentrate. The extractor reject/concentrate is returned to the concentration tank for further processing. The permeate is selectively diverted to the sterilizer for final processing or back to the concentration tank in order to balance the demand for finished water with the need for sufficient concentrated greywater to efficiently or optimally operate the extractor based on process data collected from the various sensors of the greywater recycling system. A sterilizer kills harmful microorganisms in the permeate to produce finished water ready for use with the finished water target. The details of one or more embodiments are set forth in the accompanying drawings and description below. Other features and advantages will be apparent from a reading of the following detailed description and a review of the associated drawings. It is to be understood that the following detailed description is explanatory only and is not restrictive of the invention as claimed.

### BRIEF DESCRIPTION OF THE DRAWINGS

Further features, aspects, and advantages of the present disclosure will become better understood by reference to the following figures, wherein elements are not to scale so as to more clearly show the details and wherein like reference numbers indicate like elements throughout the several views:

FIG. 1 is a simplified block diagram illustrating aspects of the greywater recycling system in an exemplary operating environment;

FIGS. 2A-2D, collectively, form a schematic diagram illustrating aspects of the greywater recycling system; and

FIG. 3 is a high level flowchart illustrating aspects of the greywater recycling method.

### DETAILED DESCRIPTION

A greywater recycling system and accompanying method are described herein and illustrated in the accompanying figures. The system is designed using flow control management and minimally-sized holding tanks allowing use of on-site greywater recycling in locations where conventional greywater recycling systems are unsuitable. Where conventional greywater recycling systems produce low-value recycled water suitable for use in irrigation, the greywater recycling system produces high-value recycled water suitable for use in other systems, such as cooling towers with minimal impact on the facility and changes to existing processes. By using higher capacity extraction, reducing the size of storage tanks, and returning permeate to supply the extractor, as needed, the system operates efficiently with a greywater source producing a non-continuous flow of greywater while being modular and compact.

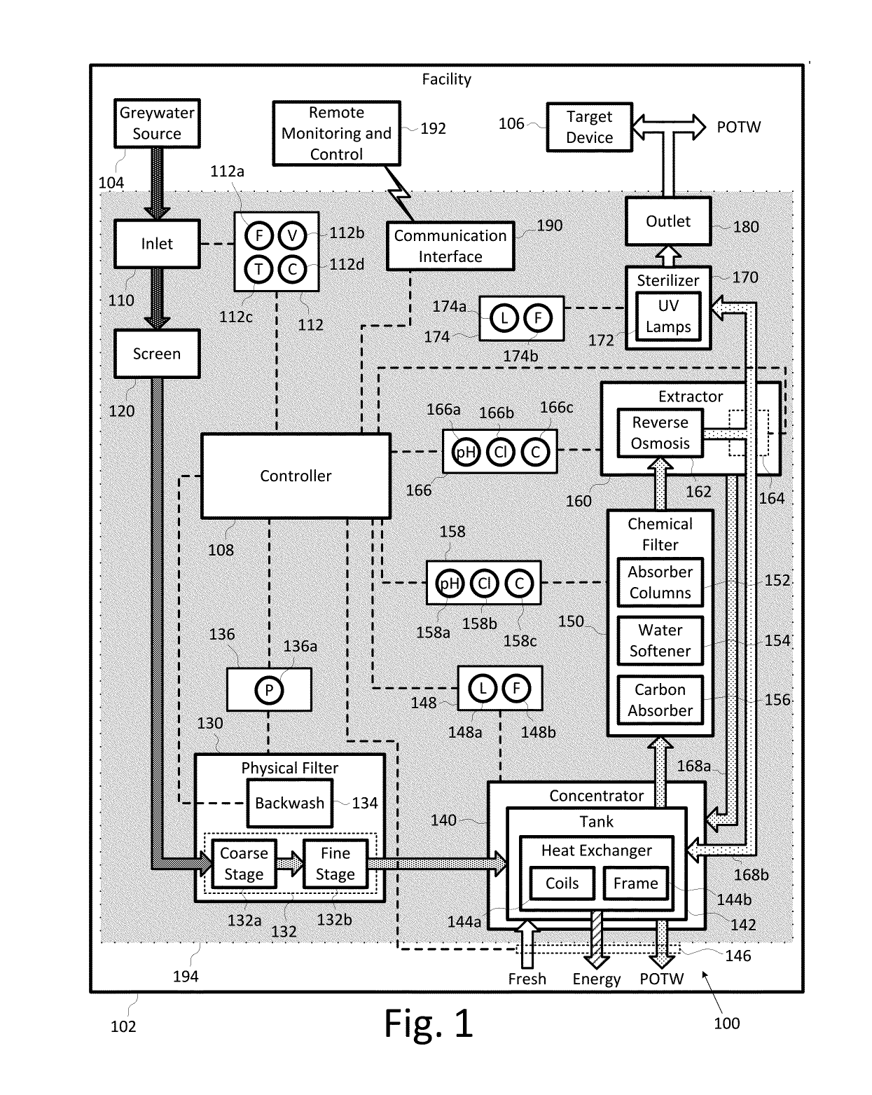

FIG. 1 is a simplified block diagram illustrating aspects of the greywater recycling system in an exemplary operating environment. The greywater recycling system 100 is suitable for use at a facility 102 that produces a significant amount of greywater on a regular basis but does not have a corresponding need for irrigation. Examples of facilities that benefit from the greywater recycling system 100 include, without limitation, hotels, motels, hospitals, universities, food processing plants, power plants, manufacturing plants, and commercial laundries. Often such facilities are located in urban or industrial environments with little-to-no landscaping or higher volume uses that could make use of recycled greywater. For example and without limitation, such facilities often utilize water-cooled chillers for air-conditioning, cooling equipment (e.g., lasers, magnetic resonance imaging equipment) generating large amounts of heat, cooling materials used in (e.g., metal working cutting oils) various industrial processes. Unlike irrigation, manufacturers of cooling towers, water-cooled chillers, and similar equipment specify minimum water quality requirements for water used in such equipment that are much higher than irrigation quality recycled greywater. Generally, such facilities generate large amounts of greywater in batches (e.g., at various points in the laundry cycle or in an industrial process) rather than producing a continuous flow of greywater.

In the illustrated embodiment, the greywater recycling system 100 is installed on-site at the facility 102. The greywater recycling system 100 accepts the greywater in batches from the batch greywater source 104, recycles the greywater, and supplies the recycled greywater to the target equipment 106. Aspects of the greywater recycling system 100 include a process controller 108, an inlet 110, a gross solid screen 120, a physical filter 130, a concentrator 140, a chemical filter 150, a dissolved solids removal component 160, a sterilization component 170, and an outlet 180. In order to illustrate a specific utility, the greywater recycling system 100 is described in the context of a facility 102 recycling greywater generated by the on-site laundry (i.e., a particular example of a suitable batch greywater source 104) and reused in a cooling tower or a water-cooled chiller (i.e., particular examples of suitable target equipment 106) that provides cooling for the facility 102. However, references to a particular application or particular devices used therein are not intended to and should not be construed to limit the scope of the greywater recycling system 100 or its general applicability to a particular application in any way.

The process controller 108 monitors the greywater from input and output and controls the greywater recycling process sequences through monitoring and control of the various components of greywater recycling system 100. Aspects of the process controller 108 include the ability to receive input from external systems and manual inputs from human operators to configure parameters of the greywater recycling process. For example, the process controller 108 may receive input specifying the demand for finished water by the finished water target 106. The demand input may be automatically provided by a control system of the finished water target 106 or manually provided by a human operator. Further, the demand may be specified as a minimum demand value and a maximum demand value.

The process controller 108 may be implemented in hardware, firmware, software, or a combination thereof using any device capable of providing logical and mathematical operations and any associated memory. Specially, the process controller 108 may be implemented using discrete components and integrated circuits (digital or analog) or a single integrated circuit or package, such as an application specific integrated circuit (ASIC), a field-programmable gate array (FPGA), a system-in-a-package (SiP), or a system-on-a-chip (SoC). The process controller 108 may also be implemented as a special purpose computing device. The claimed invention is not limited to electronic technologies and embodiments of the invention may be practiced using any technology capable of performing logical and/or mathematical operations.

One aspect of the greywater recycling system 100 is the ability to implement the process controller 108 as a single centralized controller managing a single greywater recycling system 100. Another aspect of the greywater recycling system 100 is the ability to implement the process controller 108 as multiple distributed controllers, each associated with one or more components of the greywater recycling system 100. Yet another aspect of the greywater recycling system 100 is the ability to implement the process controller 108 as a single shared controller that remotely manages multiple greywater recycling systems 100.

The inlet 110 is in fluid communication with the laundry 104 to accept the greywater into the greywater recycling system. The inlet 110 includes piping that physically delivers the water from the discharge outlet of the laundry 104 to the first process component of the greywater recycling system. The inlet is instrumented with various inlet sensors 112 in communication with the process controller 108. The inlet sensors 112 allow the process controller 108 to monitor and measure the supply and characteristics of the greywater for control of the downstream system components. A typical embodiment of the inlet includes a flow rate sensor 112a, flow volume (i.e., totalized flow) sensor 112b, a temperature sensor 112c, and a conductivity sensor 112d. The process controller 108 utilizes the flow rate and temperature data to calculate water balance for feed-forward decisions controlling the concentrator tank level and finished (i.e., recycled) water discharges. The process controller 108 also utilizes the flow rate and temperature data to calculate thermal balance for feed-forward decisions controlling the operation of energy recovery in the concentrator 140 and associated energy replacement components (e.g., the laundry water pre-heating system). Based on application specific conditions and/or requirements, one or more of the previously mentioned inlet sensors 112 may be omitted or other inlet sensors 112 may be added. Moreover, although referred to in the singular, multiple sensors may be used.

The inlet 110 is in fluid communication with the gross solid screen 120. The gross solid screen 120 includes one or more application-specific screens to strain gross solids in the greywater are likely to clog or damage downstream components of the greywater recycling system 100. The application-specific screens are selected to make efficient use of existing greywater source discharge sewer and tanks. For example, in a laundry application, screens may be used to capture strings and other large objects. The inlet sensors 112 are optionally deployed before, after, or both before and after the gross solid screen 120.

The output of the inlet 110 or gross solid screen 120 feeds the physical filter 130. The physical filter 130 includes a multiple-stage physical filter 132 for removing solid particles from the greywater. Typically, the stages progress from coarse to fine, with each successive stage removing gradually smaller particles from the greywater. The number of stages and the minimum particle size captured at each stage are application specific. For example, greywater from the laundry may be filtered using a two-stage filter having coarse stage and a fine stage. The coarse stage filters 132a are configured to capture and hold a high volume of larger particles and are easily cleaned. The fine stage filters 132b capture smaller solids that are missed by the first stage filters.

Optional aspects of the greywater recycling system 100 include the use of an automatic back-flushing component 134 to promote ease of operation and facilitate cleaning of one or more stages of the multiple-stage physical filter 132. Further, the greywater recycling system 100 optionally uses dual-inline filters allowing greywater flow to be diverted between alternate filter housings so the filters may be changed or cleaned without taking the greywater recycling system 100 offline.

The physical filter 130 is instrumented with physical filter sensors 136 including pressure sensors 136a in communication with the process controller 108 to measure the pressure drop across the solid particle filters. The process controller 108 uses the pressure measurements to determine when the filters need to be cleaned and to control operation the backwash and cleaning cycles of the physical filter 130. Based on application specific conditions and/or requirements, other filtration sensors 136 may be added.

The concentrator 140 is in fluid communication with the physical filter 130 and the extractor 160. The concentrator 140 includes a concentrator tank 142 where filtered greywater from the physical filter 130 is blended with extractor reject/concentrate, permeate, and, optionally, fresh water (e.g., from a public water utility). The concentrator tank 142 concentrates the pollutants in the stored greywater. The concentrated water and used to equalize flow rates within the greywater recycling system 100.

Optionally, the concentrator tank 142 is configured with energy recovery components 144, such a heat exchanger with an external plate-frame 144a, a heat exchanger with an internal coils 144b, or both for energy recovery and/or to reduce the water temperature. Energy recovered by the concentrator 140 is usable for pre-heating fresh laundry water or other purposes at the facility 102. In a typical laundry application, the average water temperatures are 15.5° C. (60° F.) for the incoming fresh water from the public water utility and 48.9° C. (120° F.) for the heated water used in the laundry application. The greywater recycling system 100 cools the heated water to an average temperature of 21.1° C. (70° F.). In a laundry application with a water consumption of approximately 50,000 gallons per day, energy recovery of approximately 22,000,000 kilojoules (20,850,000 BTU) per day is achievable. At a cost of $6 per decatherm, the savings to the facility 102 is approximately $125 per day or $45,600 per year.

The concentrator 140 is instrumented with concentrator sensors 148 in communication with the process controller 108. The concentrator sensors 142 include a fluid level sensor 148a to measure the volume of fluid held by the concentrator tank 142 and flow rate sensors 148b to measure fluid flow rates into the concentrator tank 142. The concentrator sensors 148 measure the fluid flow from the various inputs (e.g., the greywater and being fed into the concentrator tank 142 and the fluid level of the concentrator tank 142. The process controller 108 uses the measured fluid level and fluid flows to optimize operation of the extractor balanced with finished water demand. Additionally, the process controller 108 uses the temperature of the water in the concentrator tank 142 and flow rate and temperature (energy) of the greywater supplied to the concentrator tank 142 to balance the energy demand for fresh water.

The process controller 108 uses the measured fluid level and fluid flows to calculate the appropriate flow rate of permeate into the concentrator tank 142 and adjusts the associated automatic flow control valves 146 to regulate the inflow of permeate and/or fresh water according to the calculated flow rates to manage the fluid level of the concentrator tank 142. If the flow of greywater and return concentrate or the level of the concentrator tank 142 is insufficient to supply the extractor 160 for efficient or optimal operation or to meet the finished water demand, the process controller 108 may automatically open control valves for the permeate and/or fresh water supply to increase the output flow from the concentrator tank 142. Further, the process controller 108 may divert excess water from the concentrator tank 142 to a publicly owned treatment works (POTW) or an alternate target (e.g., an irrigation system) or reduce the water level in the concentrator tank 142 to accommodate an incoming surge. If the pollutant levels in or the temperature of the water being fed to the extractor 160 are too high for efficient or optimal operation, the process controller 108 may dilute the water in the concentrator tank 142 with permeate and/or fresh water supply to reduce the concentrations and/or water temperature. Similarly, if the concentration of pollutants in the concentrated water is below the level for efficient or optimal operation of the extractor, water may be discarded via a drain (e.g., flushed to the POTW) allowing the concentrations to increase as incoming greywater fills the concentrator tank 142. The measurements obtained using the concentrator sensors 148 are also used by the process controller 108 to control operation of downstream components of the greywater recycling system 100.

The chemical filter 150 removes selected chemicals from the concentrated greywater. The chemical filter 150 includes absorber columns 152 operated in series for removal of the target chemicals. A water softener system 154 reduces or eliminates the presence of minerals (e.g., calcium, magnesium, and iron) increasing water hardness in the concentrated greywater. A carbon absorption system 156 reduces or eliminates the presence of chlorine and other soluble organics in the concentrated greywater.

The chemical filter 150 is instrumented with chemical filter sensors 158 in communication with the process controller 108. In various embodiments, the chemical filter sensors 158 include a pH sensor 158a, a chlorine (or other soluble organic) sensor 158b, and a conductivity (or other water hardness) sensor 158c. The chemical filter sensors 158 are optionally deployed before, after, or both before and after the chemical filter 150 to measure the corresponding characteristics of the greywater feeding the chemical filter 150 and the corresponding characteristics of the greywater after processing by the chemical filter 150.

Target chemicals in the water entering and leaving the absorber columns 152 are measured. Chlorine is removed to protect the reverse osmosis membranes in the extractor 160. Water softening is furnished to remove hardness and minerals (calcium, magnesium, iron) to improve quality and to minimize or prevent precipitation in the concentrate. The process controller 108 monitors specific chemical removal for optimizing the life of the absorber columns 152.

Input side chemical filter sensors 158 are used by the process controller 108 to adjust the process parameters or operation of the chemical filter 150 to the specific characteristics of the greywater feeding the chemical filter 150. For example, many treatment processes are sensitive to pH, and the process controller 108 may adjust process time or additive amounts used in the process sequence of the chemical filter 150 or may introduce pH adjusting additives prior to treating the greywater. Similarly, output side chemical filter sensors 158 are used by the process controller 108 for various purposes such as, but not limited to, determining when the chemical filter 150 is complete and verifying operation of the chemical filter 150. For example, if the pH or soluble organic levels of the greywater exiting the chemical filter 150 are not within acceptable tolerances for the target equipment 106, the process controller 108 may actuate the automatic control valves to route that greywater back through the chemical filter 150 or trigger an alert indicating that the chemical filter 150 is malfunctioning.

Based on application specific conditions and/or requirements, one or more of the previously mentioned chemical filter sensors 158 may be omitted or other chemical filter sensors 158 may be added. For example, if water hardness is not an important characteristic for the recycled water supplied to the target equipment 106, the conductivity sensor 158c may be omitted. Similarly, for example, if fluorine level is also an important characteristic, a fluorine sensor may be added.

The extractor 160 is in fluid communication with the chemical filter 150 and removes dissolved solids from the chemically filtered greywater. The extractor 160 includes a reverse osmosis membrane rack 162 and an automatically controlled return valve package 164 (i.e., automatic valve rack). The output of the reverse osmosis membrane rack 162 is in fluid communication with the return valve package. Reject water and concentrate is returned to the concentrate tank for further processing (i.e., water that did not pass through the membrane and still contains dissolved solids) via reject return 168a. The return valve package includes automatic permeate/reject split flow valves controlled the process controller 108 to direct permeate (i.e., water passing through the membrane with dissolved solids removed) between the sterilizer 170 and the concentrator tank 142 via permeate return 168b. In various embodiments, the return valve package optionally directs a portion of any excess permeate (i.e., permeate produced in excess of the maximum demand of the finished water target 106) to the POTW or an alternate target. For example, a portion of the excess permeate may be drained to the POTW rather than returned to the concentrator tank in order to manage the water temperature. In other words, the process controller 108 balances the input flow for efficient or optimal extractor operation with energy recovery based on the measured flow rates and water temperature.

The extractor 160 is instrumented with extraction sensors 166 in communication with the process controller 108. In various embodiments, the extraction sensors 166 include a flow rate sensor, a conductivity sensor 166b, and pressure sensors 166c for measuring the pressure across the membranes of the reverse osmosis membrane rack 162. The measured conductivity (i.e., dissolved solids) entering and leaving the extractor is measured. The process controller 108 uses the measured conductivity to maintain the supply of feed water into the extractor at an efficient or optimum production level relative to the demand for finished water on the greywater recycling system 100 and other process constraints. The automatic valve rack 164 and other automatic flow direction valves are controlled by the process controller 108 based on the operating parameters of the greywater recycling system 100 including the greywater flow rate, finished water reuse demand, concentrator tank capacity, extractor optimum performance range, and optionally, energy recovery optimization. For example, the output of permeate directed to the sterilizer may be reduced to meet the minimum demand level of the finished water target 106 and excess permeate above the minimum demand level returned to the concentrator tank when additional greywater is need to improve the efficiency of the extractor. When balancing energy recovery with extractor efficiency, the process controller 108 may return less permeate than is available to the concentrator tank to maintain the water temperature at a sufficient level to meet a configured energy recovery demand, and, if the amount of permeate supplied to the sterilizer exceeds the maximum demand constraint, the excess permeate is discarded.

Extraction systems of conventional greywater recycling systems and other wastewater management systems are designed with capacity based on the desired system output and large surge volumes may easily outstrip the extractor system capacity on a momentary basis. Accordingly, conventional greywater recycling systems utilize storage tanks to hold incoming greywater until it can be processed by the extraction system. Such storage tanks are typically sized to hold large volumes of greywater that are processed over time to produce finished water. For example, the laundry process may have large number of surges over a relatively short time that add up to a large momentary volume of greywater (i.e., a peak volume) and stored in a storage tank sized to handle the peak volume. With the oversized storage tanks, sufficient greywater is always on-hand to satisfy the capacity of the extractor system and meet the slower continuous demand rate.

Rather than oversizing greywater storage, the capacity of the reverse osmosis membrane stack 162 of the greywater recycling system 100 is increased allowing faster greywater processing. This departure in operation from conventional wastewater extraction systems allows the volume of the holding tanks to be reduced in the greywater recycling system 100. Because the extractor capacity planning is based on greywater input surges, as well as finished water output, the extractor 160 is generally capable of generating permeate at a greater rate than rate than it is received. Some finished water targets 106 are capable of accepting finished water from the greywater recycling system 100 as quickly as it is generated. Because, at any given time, the amount of greywater in the concentrator tank 142 from the greywater source 104 alone may not be adequate for efficient or optimal operation of the extractor 160. To handle this contingency, the process controller 108 maintains the concentrations and flow rate of water to the extractor and the finished water output by returning permeate to the concentrator tank 142 until it is needed by the finished water target 106 and/or additional surges of greywater are received from the greywater source 104. In other words, the extractor 160 is operated to optimize permeate recovery and, despite the use of a smaller tank, the overall operation of the greywater recycling system 100 is maintained by recycling at least some of permeate to the concentrate tank 142.

The sterilization component 170 disinfects and/or sterilizes the greywater using ultraviolet light in wavelengths suitable to kill selected infectious microorganisms (e.g., viruses, bacteria, bacterium, prions, fungi, or protozoa). The sterilization component 170 includes one or more ultraviolet lamps 172 that emit wavelengths in the ultraviolet spectrum. The greywater is exposed to the ultraviolet light, for example and without limitation, as it passes through a pipe that is transparent to the ultraviolet spectrum or a pipe containing ultraviolet lamps sealed in moisture-tight and ultraviolet-transparent enclosures.

The sterilization component 170 is instrumented with sterilization sensors 174 in communication with the process controller 108. In various embodiments, the sterilization sensors 174 include a flow control sensor 174a and, optionally, a temperature sensor 174b. The process controller 108 utilizes the measured flow rate and energy of greywater into the sterilization component to control operation of the ultraviolet lamps used to sterilize and disinfect the greywater. The flow rate measured by the flow control sensor 174a also represents the output flow rate of finished water from the greywater recycling system 100. The process controller 108 uses the output flow rate to match the demand of the finished water target 106.

Finished water is directed to the outlet 180 in fluid communication with the finished water target 106. If more finished water is generated than can be used by the finished water target 106, automatically controlled diverter valves 182 allow excess finished water to be returned to the POTW and/or diverted to an alternate target.

A communication interface 190 allows communication between the process controller 108 and one or more suitable remote computing devices 192. When running a monitoring and/or control application, the remote computing devices 192 may be used for remote monitoring and/or control of the greywater recycling system 100. The monitoring and/or control application may be executed at the remote computing device 192 (e.g., a local application) or executed at or served by the process controller 108 (e.g., a web-based application or interface). The remote computing devices 192 may be special purpose computing devices or general purpose computing devices (e.g., personal computers, tablets, or mobile phones) that become special purpose computing devices when executing the monitoring and/or control application or interface.

In various embodiments, the process controller 108 communicates with the various sensors and with the remote computing device 192 via a direct connection or over a network, such as a local area network, a wide area network, or the Internet. The interface for such direct or network communications may be a wired or wireless interface.

One or more sensors may be omitted from, added to, or substituted for any of the various components of the greywater recycling system 100. One type of sensor may be replaced with a sensor of a different type and the basis for decisions made by the process controller 108 adjusted to utilize the new sensor data type to provide the functionality of the greywater recycling system 100 described herein. For example, a flow rate sensor may be substituted with a totalized flow sensor and the corresponding decisions made the process controller 108 adjusted to be based on fluid volume rather than the instantaneous flow rate of the fluid. Further, while the foregoing description of sensors for the various components of the greywater recycling system 100 refers to some sensors as singular or plural, such references are not intended to limit the number of sensors. In other words, a sensor referenced in the singular may be implemented as multiple sensors, and sensors referenced in the plural may be implemented as singular sensor. For example, a single flow sensor may be replaced with multiple flow sensors (e.g., an inlet flow sensor and an outlet flow sensor).

Another optional aspect of the greywater recycling system 100 is the modular nature of the greywater recycling system 100 allowing most or all of the components to be integrated in a single structure or module 194 (i.e., housing) depicted by the dotted line. In the illustrated embodiment, the footprint of the housing 194 is The housing 194 holds the process controller 108, the inlet 110, the screen 120, the physical filter 130, the concentrator 140, the chemical filter 150, the extractor 160, the sterilizer 170, the outlet 180, and the communication interface 190. Accordingly, by increasing the capacity of the reverse osmosis membrane rack 162 and reducing the size of the storage tanks (e.g., the concentrator tank 142), the modular design allows the greywater recycling system 100 to be located in a relative small area on the facility property. Moreover, the modular design allows the greywater recycling system 100 to be fabricated off-site in pre-configured or custom configurations and supplied as a drop-in-place system, which only requires connection of the output of the greywater source 104 and the input of the finished water target 106 to the inlet 110 and outlet 180, respectively, and any energy return or alternate output connections. The modular design also allows the greywater recycling system 100 to be implemented as a self-contained and/or enclosed system.

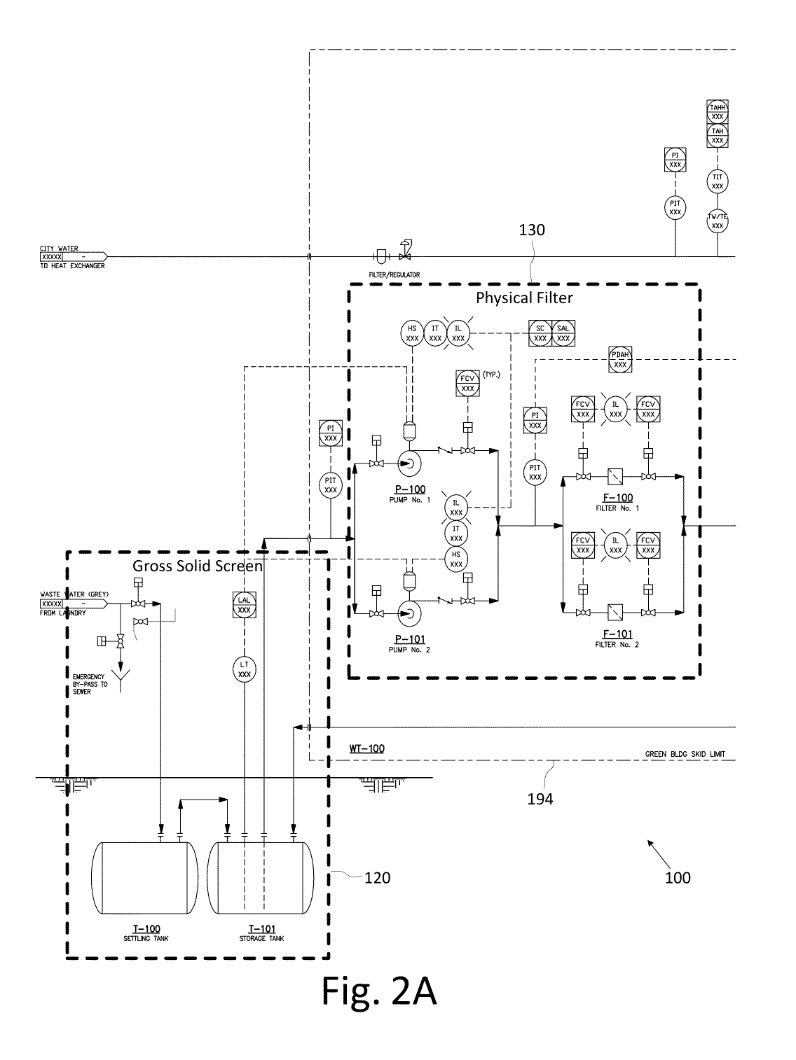

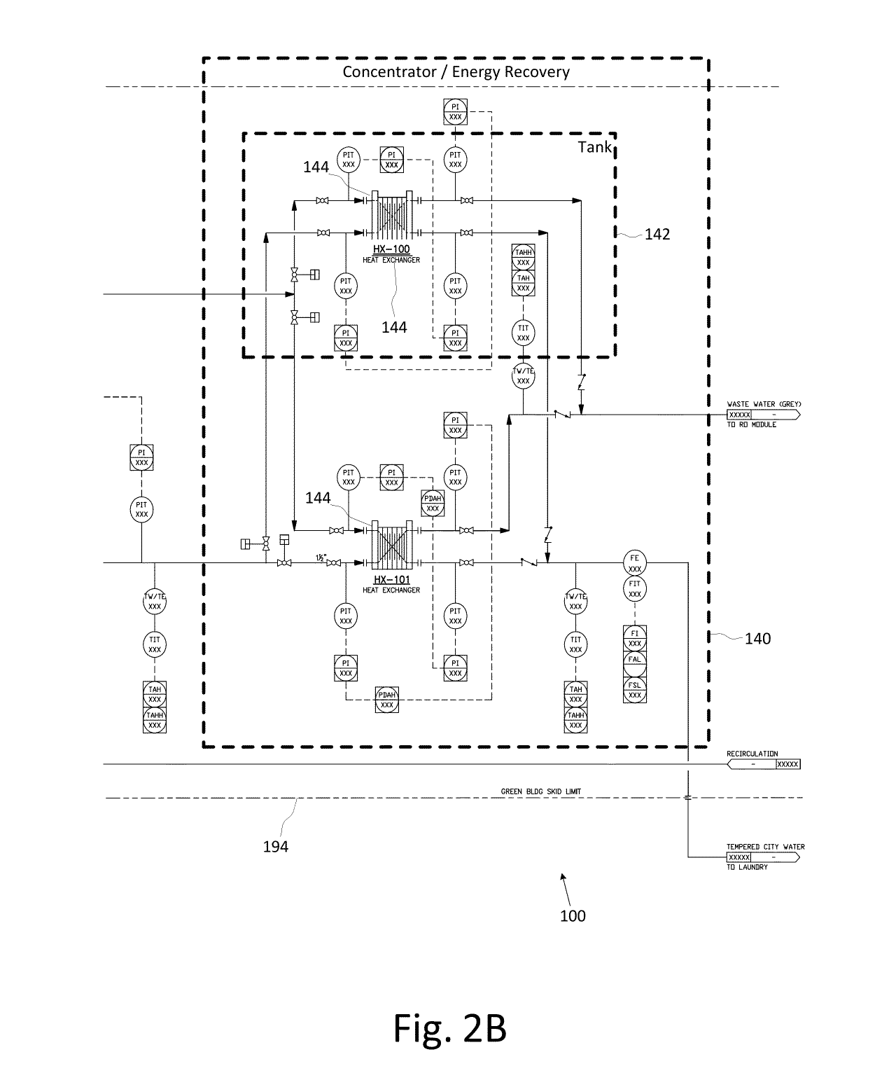

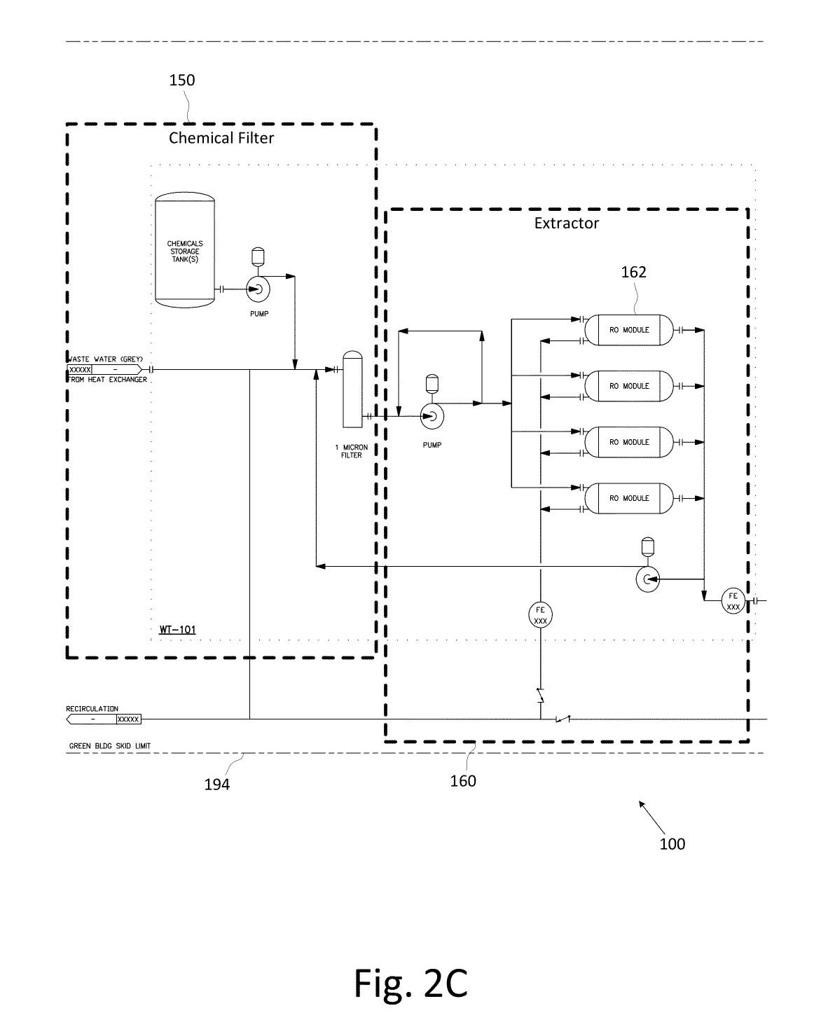

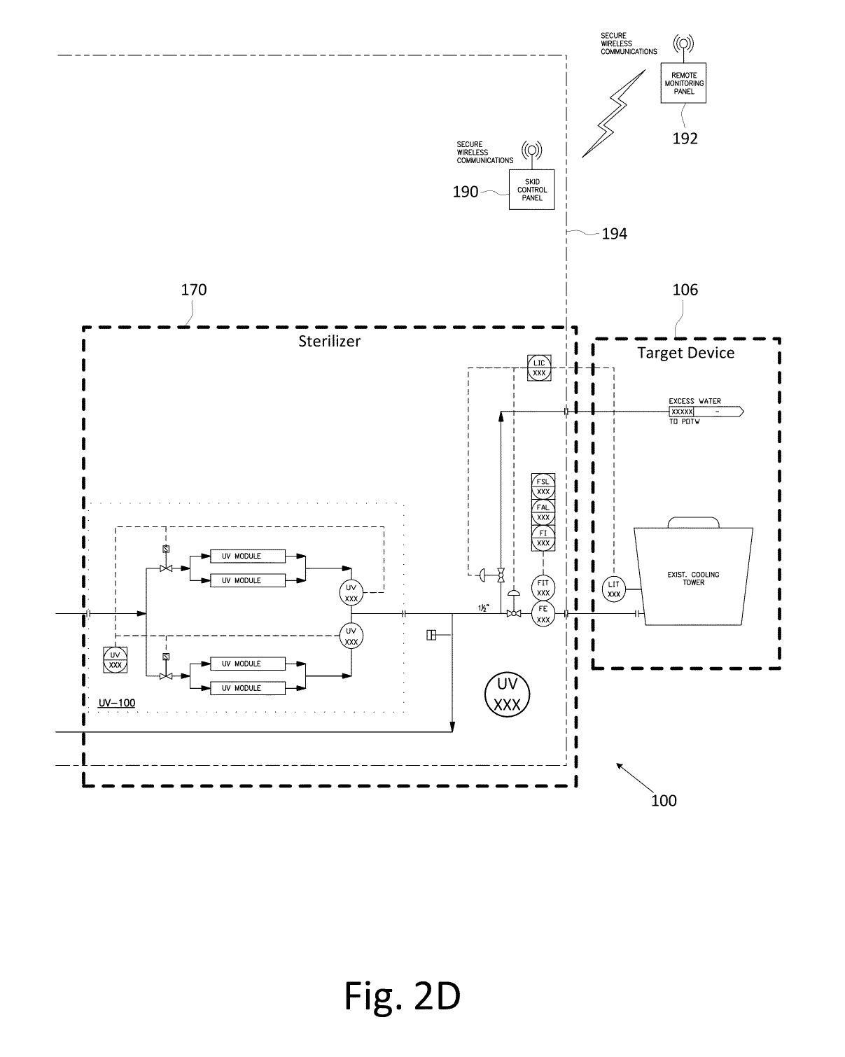

FIGS. 2A-D, collectively, form a schematic diagram illustrating aspects of the greywater recycling system shown in FIG. 1. While the foregoing discussion fully describes the design and operation of the greywater recycling system 100, the schematic shows various pumps, instrumentation, controls, and other routine or application-specific components of wastewater and other fluid handling systems. The use of such components will be readily appreciated by those skilled in the art.

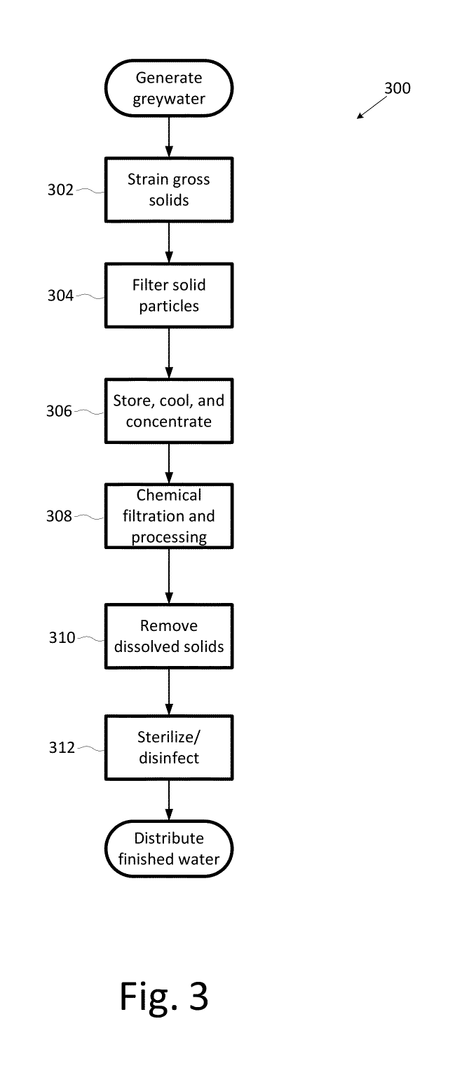

FIG. 3 is a high level flowchart illustrating aspects of the greywater recycling method. The method 300, previously discussed in connection with the foregoing component description, is summarized below. The method 300 begins with the generation of greywater by a greywater source. Gross solids are removed from the greywater by a gross solid screening operation 302. The screened greywater is then passed through one or more physical filters to remove solid particles in a solid particle filtration operation 304. The filtered greywater is stored, cooled, and concentrated during a concentration operation 306. Energy is optionally recovered during the concentration operation 306. The concentrated greywater is then processed to remove undesirable chemicals and adjust the pH or other parameters of the concentrated greywater in a chemical filtration operation 308. Once chemical processing is completed, an extraction operation 310 uses reverse osmosis to separate the greywater into permeate and reject/concentrate. The extractor reject/concentrate is returned to the concentration tank for further processing. The permeate is selectively diverted to the sterilizer for final processing or back to the concentration tank in order to balance the demand for finished water with the need for sufficient concentrated greywater to efficiently or optimally operate the extractor based on process data collected from the various sensors of the greywater recycling system. A sterilization operation 312 kills harmful microorganisms in the permeate to produce finished water ready for use with the finished water target.

The description and illustration of one or more embodiments provided in this application are intended to provide a complete thorough and complete disclosure the full scope of the subject matter to those skilled in the art and not intended to limit or restrict the scope of the invention as claimed in any way. The embodiments, examples, and details provided in this application are considered sufficient to convey possession and enable those skilled in the art to practice the best mode of claimed invention. Descriptions of structures, resources, operations, and acts considered well-known to those skilled in the art may be brief or omitted to avoid obscuring lesser known or unique aspects of the subject matter of this application. The claimed invention should not be construed as being limited to any embodiment, example, or detail provided in this application unless expressly stated herein. Regardless of whether shown or described collectively or separately, the various features (both structural and methodological) are intended to be selectively included or omitted to produce an embodiment with a particular set of features. Further, any or all of the functions and acts shown or described may be performed in any order or concurrently. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

What is claimed is:

1. A greywater recycling system comprising:
a system inlet in fluid communication with a greywater source;
a multiple-stage filter in fluid communication with the system inlet, the multiple-stage filter removing solid particles from the greywater;
a concentrator tank in fluid communication with the multiple-stage filter;
a concentrator tank level sensor measuring the volume of the greywater in the concentrator tank;
an extractor having an inlet in fluid communication with the concentrator tank, the extractor removing dissolved solids from the greywater to generate permeate and reject, the extractor having a permeate output and a reject return, the reject return in fluid communication with the concentrator tank to return reject to the concentrator tank;
an extractor inlet flow sensor measuring the flow of greywater into the extractor;
an automatic permeate diverter valve in fluid communication with the permeate output, the automatic permeate diverter valve having a first outlet in fluid communication with the sterilizer and a second outlet in fluid communication with the concentrator tank;
a sterilizer in fluid communication with the automatic permeate diverter valve, the sterilizer disinfecting the permeate to produce finished water;
a system outlet in fluid communication with the sterilizer to deliver the finished water to a finished water target; and
a process controller in communication with the concentrator tank level sensor, the extractor inlet flow sensor, and the automatic permeate diverter valve, the process controller selectively diverting a portion of the permeate to the concentrator tank.

2. The greywater recycling system of claim 1 further comprising a sterilizer flow sensor in communication with the process controller, the sterilizer flow sensor measuring an output of finished water from the sterilizer.

3. The greywater recycling system of claim 2 wherein the process controller is configured with a selected system output and calculates a permeate return flow to return excess permeate after meeting the selected system output.

4. The greywater recycling system of claim 2 wherein the finished water target has a demand for finished water and the process controller calculates a permeate return flow based on matching the sterilizer flow with the demand for finished water.

5. The greywater recycling system of claim 1 wherein the concentrator tank includes a heat exchanger for cooling the greywater.

6. The greywater recycling system of claim 5 wherein energy recovered by the heat exchanger is redistributed to an external system, the greywater recycling system further comprising a concentrator tank temperature sensor in communication with the process controller, the concentrator tank temperature sensor measuring the temperature of the greywater in the concentrator tank.

7. The greywater recycling system of claim 6 wherein the process controller calculates a permeate return flow to balance energy recovery by the heat exchanger with efficient operation of the extractor and adjusts the automatic permeate diverter valve to divert a selected portion of the permeate based to the concentrator tank based on the calculated permeate return flow.

8. The greywater recycling system of claim 7 wherein the extractor inlet flow sensor is a flow rate sensor and the permeate return flow is a flow rate.

9. The greywater recycling system of claim 1 further comprising a chemical filter in fluid communication between the concentrator tank and the extractor.

10. The greywater recycling system of claim 1 wherein the system inlet further comprises a gross solid screen for removing gross solids from the greywater.

11. The greywater recycling system of claim 1 wherein the system inlet receives a non-continuous flow of greywater from the greywater source.

12. A greywater recycling system comprising:
a system inlet in fluid communication with the greywater source to receive a non-continuous flow of greywater from the greywater source;
a multiple-stage filter in fluid communication with the system inlet, the multiple-stage filter removing solid particles from the greywater;
a concentrator tank in fluid communication with the multiple-stage filter;
a heat exchanger for cooling the greywater in the concentrator tank and redistributing energy recovered from the greywater to an external system;
a concentrator tank level sensor measuring the volume of the greywater in the concentrator tank;
a concentrator tank temperature sensor measuring the temperature of the greywater in the concentrator tank;
a chemical filter in fluid communication with the concentrator tank;
an extractor in fluid communication with the chemical filter, the extractor removing dissolved solids from the greywater to generate permeate and reject, the extractor having a permeate output and a reject return, the reject return in fluid communication with the concentrator tank to return reject to the concentrator tank;
an extractor inlet flow sensor measuring the flow of greywater into the extractor;
an automatic permeate diverter valve in fluid communication with the permeate output, the automatic permeate diverter valve having a first outlet in fluid communication with the sterilizer and a second outlet in fluid communication with the concentrator tank;
a sterilizer in fluid communication with the automatic permeate diverter valve, the sterilizer disinfecting the permeate to produce finished water;
a sterilizer flow sensor measuring an output of finished water from the sterilizer;
a system outlet in fluid communication with the sterilizer to deliver the finished water to a finished water target; and
a process controller in communication with the concentrator tank level sensor, the concentrator temperature sensor, the extractor inlet flow sensor, the sterilizer flow sensor, and the automatic permeate diverter valve, the process controller selectively diverting a portion of the permeate to the concentrator tank.

13. The greywater recycling system of claim 12 wherein the process controller is configured with a selected system output and calculates a permeate return flow to return excess permeate after meeting the selected system output based on the measured output of the sterilizer flow sensor.

14. The greywater recycling system of claim 13 wherein the selected system output is based on a demand for finished water specified for the finished water target.

15. The greywater recycling system of claim 13 further comprising a system inlet flow sensor measuring the flow of greywater from the greywater source.

16. The greywater recycling system of claim 15 wherein the process controller further bases the permeate return flow on the concentrator tank greywater volume and the greywater source flow to maintain a selected volume of greywater in the concentrator tank to supply the extractor for efficient operation.

17. The greywater recycling system of claim 15 wherein the process controller adjusts the automatic permeate diverter valve to divert a selected portion of the permeate to the concentrator tank based on the calculated permeate return flow.

18. The greywater recycling system of claim 17 wherein the process controller further bases the permeate return flow on the concentrator tank greywater temperature to balance energy recovery by the heat exchanger with efficient operation of the extractor.

19. The greywater recycling system of claim 12 wherein the outlet is an automatic diverter value having a first outlet in fluid communication with the finished water target outlet and second outlet in fluid communication with a drain for discarding excess finished water.

20. The greywater recycling system of claim 12 wherein the system inlet further comprises a gross solid screen for removing gross solids from the greywater.
